(19) United States
(12) Patent Application Publication
(10) Pub. No.: US 2006/0289209 A1
(43) Pub. Date: Dec. 28, 2006

(54) Electromotive drive module

(75) Inventors: Wolfgang Grosspietsch, Schweinfurt (DE); Jorg Sudau, Niederwerrn (DE); Rudiger Herbst, Viereth-Trunstadt (DE); Christoph Kleuker, Gochsheim (DE); Manfred Zimmer, Zeil (DE); Thomas Busold, Fulda (DE); Steffen Matschas, Schweinfurt (DE); Thorsten Muller, Wurzburg (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/472,190

(22) Filed: Jun. 21, 2006

(30) Foreign Application Priority Data
Jun. 22, 2005 (DE) 10 2005 029 305.0
Sep. 16, 2005 (DE) 10 2005 044 225.0
Nov. 11, 2005 (DE) 10 2005 053 887.8

(51) Int. Cl. B60K 6/02

(52) U.S. Cl. 180/65.2

(57) ABSTRACT

An electromotive drive module for installation in a housing between an internal combustion engine and a transmission of a motor vehicle power train. The drive module includes an electric machine with a stator and a rotor and first and second clutch devices, by means of which the rotor can be connected when desired to the internal combustion engine and/or to the transmission for the transmission of torque.

### BACKGROUND OF THE INVENTION

1. Field of the Invention

The invention pertains to an electromotive drive module for installation in a motor vehicle powertrain with an internal combustion engine and a transmission.

2. Description of the Related Art

It is well known that the integration of one or more electric machines into the powertrain of a motor vehicle and the realization of purely electric powertrains and of hybrid powertrains combining an electric motor with an internal combustion engine have been a long-term development goal of the automotive industry for many years. The efforts in this direction have intensified especially in recent years because of the continuous increase in the cost of fuel and the demand to reduce the pollution caused by internal combustion engines. Fundamental technical problems of integrating electric drives into motor vehicle powertrains have already been solved, but considerable cost problems still stand in the way of customer acceptance and thus of rapid market introduction. These cost problems are attributable at least in part to the fact that, to achieve the greatest possible functionality and/or a very high performance level for a hybrid vehicle, the entire powertrain has to be redesigned, which means that a great deal of modification and development work is required in association with massive changes to existing systems.

### SUMMARY OF THE INVENTION

Against this background, the present invention is based on the problem of integrating an electric machine into a conventional vehicle powertrain, that is, a powertrain equipped with an internal combustion engine and a transmission, in such a way as to provide an especially low-cost hybrid powertrain.

According to the invention, an electromotive drive module represents a structural unit which includes the electric machine and two clutches and which is designed specifically to be installed in the vehicle's powertrain. With the help of the clutches, the rotor of the electric machine can be connected as desired either to the internal combustion engine, to the transmission, or to both the internal combustion engine and the transmission for the transmission of torque. A module of this type can be manufactured by a supplier, for example, with the use of standard components under automated conditions and thus at low cost. For installation, the module can be easily accommodated in its entirety inside the bell housing of a gear-shift transmission and mounted in place there. As a result, vehicle manufacturers can save considerable assembly time and cost, and the associated risks can also be eliminated. Because there are in practice only a limited number of standard transmission types, a module of this type can be used universally in various vehicle platforms.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an electromotive drive module 18a in a motor vehicle powertrain, the module containing an electric machine and first and second clutches for interacting with an internal combustion engine and a transmission; where the input and output elements of the first clutch are supported on an intermediate housing wall;

FIG. 2 shows a drive module 18b without the intermediate housing wall shown in FIG. 1, where the input element of the first clutch is supported by the crankshaft of the internal combustion engine;

FIG. 3 shows a drive module 18c according to FIG. 1, where the first clutch can be actuated by means of a hydraulic cylinder supported on an intermediate housing wall;

FIG. 4 shows a drive module 18d, where the first clutch is of the “normally open” type and can be actuated by means of an actuating cylinder integrated into the intermediate housing wall, and where the clutch input element of the first clutch is supported on the clutch input element of the second clutch;

FIG. 5 shows a drive module 18e according to FIG. 4, where the first clutch is of the “normally closed” type;

FIG. 6 shows a drive module 18f with a driveplate installed in the flow of torque between the crankshaft of an internal combustion engine and the input element of the first clutch, a torsion damper being integrated into the driveplate;

FIG. 7 shows a drive module 18g with a torsional vibration damper arrangement upstream of the second clutch, the input part of which arrangement is permanently connected to the rotor of the electric machine;

FIG. 8 shows a drive module 18h according to claim 7, where the inner plate carrier of the first clutch is also supported in the crankshaft; and

FIG. 9 shows a drive module 18i with an inner plate carrier supported on the intermediate housing wall.

### DETAILED DESCRIPTION OF THE PRESENTLY PREFERRED EMBODIMENTS

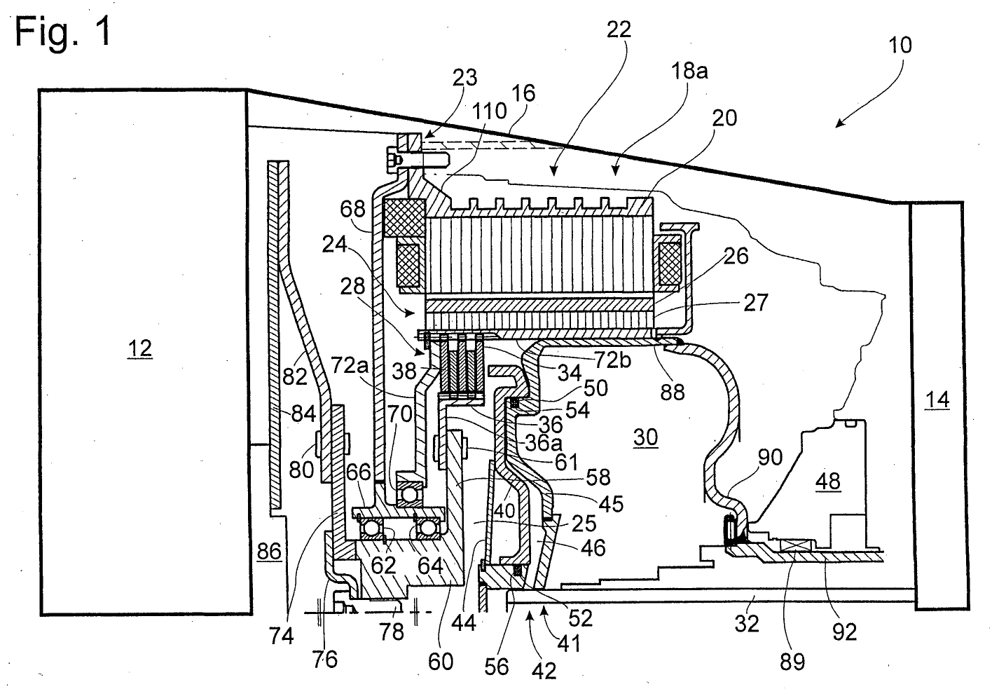

FIG. 1 is a partially schematized axial cross section of part of a conventional motor vehicle powertrain 10, originally of the conventional type from series production with an internal combustion engine 12 and a gear-shift transmission 14, which is designed here as an automatic transmission. The space present in the transmission bell housing 16 between the internal combustion engine 12 and the transmission 14 is usually reserved for a friction clutch or, in the housing of an automatic transmission, for a hydrodynamic torque converter serving as a start-up element.

It can be seen that, instead of the friction clutch or torque converter, an electromotive drive module 18a has been integrated into the powertrain inside the transmission bell housing 16, so that the vehicle can be driven as needed either purely by the electric motor, purely by the internal combustion engine, or by a combination of the two. For this purpose, the stator 20 of an electric machine 22 of the internal rotor type, excited by permanent magnets, is installed and nonrotatably supported inside the transmission bell housing 16 by screw joints 23, which anchor the stator carrier 110. The type of electric machine 22 is unimportant for the following discussion; that is, it can be, for example, an asynchronous (induction) machine, a reluctance machine, etc. In place of the internal rotor, which is preferred because of its compactness, furthermore, it is also possible to modify the design in such a way that an external rotor could be used.

The rotor 24, supported rotatably inside the stator 20, has a rotor carrier 72 with a radial section 72a and an axial section 72b and a laminated rotor yoke, on the outside circumferential surface of which a plurality of permanent magnets 26 is arranged, the magnetic field of which is capable of interacting with another magnetic field generated by the system of windings on the stator 20. This interaction is thus able to drive the rotor 24 and, as will become clear in the further course of this description, it can also be used to drive the vehicle or to start the internal combustion engine 12.

The rotor 24 is in working connection by means of a first, shiftable clutch 28 with the crankshaft 86 of the internal combustion engine 12 and by means of a second, also shiftable clutch 30, independent of the first, with the input shaft 32 of the transmission 14. The arrangement of the rotor 24 with the clutches 28, 30 has an extremely compact design, in that both clutches 28, 30 are arranged in a receiving space 25 inside the rotor 24, which means they require no additional axial or radial room.

The first clutch 28 is designed as a dry multi-plate clutch, where a section of the hollow cylindrical rotor 24, more precisely the axial section 72b of the rotor carrier 72, forms the outer plate carrier, carrying on its inside circumferential surface a set of teeth for accepting several outer plates 34, which are therefore able to shift axially within a certain range. Additional inner plates 38, mounted with freedom to shift axially on a toothed inner plate carrier 36, engage radially from the inside in the gaps between the outer plates. A pressure-actuated hydraulic piston 40 of an actuating device 42, comprising a hydraulic cylinder 41, can be used to exert load on the entire package formed by the plates 34, 38 in opposition to the force of a restoring element 44 designed as a disk spring or diaphragm spring 44, as a result of which torque can be transmitted between the rotor 24 and the inner plate carrier 36 and the following elements. The inner plates 38 of this dry multi-plate clutch 28 are preferably friction plates.

It can be seen that the clutch 28 is of the “normally open type”. The piston 40 is a component of a hydraulic cylinder 41, arranged concentrically around the transmission input shaft 32. The axially fixed housing of the cylinder is formed by an essentially radially oriented housing area 45 of the second clutch 30, as will be explained below. The variable pressure space 46 of the hydraulic cylinder 41 is bounded by the piston 40 and the housing area 45 and is supplied with a fluid by a pump arrangement 48 through the transmission input shaft 32, which is designed as a hollow shaft. The sealing of the pressure space 46 is accomplished by two O-ring seals 50, 52, which are inserted into ring-shaped grooves 54, 56 in the housing area 45.

The inner plate carrier 36 has a radially inward-pointing section by which it is permanently connected by riveted joints 61, for example, to a radial flange 58 of a clutch hub 60 and is supported by means of two radial bearings 62, 64, designed as roller bearings, in the interior of a tubular section 66 of an intermediate housing wall 68, which is connected to the housing or to the transmission bell housing 16 and to the stator carrier 110 by means of screw joints 23. One end of the rotor 24 of the electric machine 22 is supported on the outer circumferential surface of the tubular section 66 by way of another radial bearing 70 provided there, also a roller bearing, and by way of radial section 72a of the rotor carrier 72. On the axial side facing the internal combustion engine 12, the clutch hub 60 is in contact with a connecting disk 74, which is held axially against the clutch hub 60 by a locking disk 76 and a bolt 78 inserted into the clutch hub 60. The connecting disk is connected to the clutch hub 60 for rotation in common by means of positive-locking profiles such as serrations, which are provided on both of the elements 74 and 60 and which are thus able to engage with each other.

In its radially outer area, the connecting disk 74 is connected by means of rivets 80, for example, to an essentially rigid transmission disk 82 (driveplate). The diameter of the driveplate 82 is preferably more-or-less the same as that of the electric machine 22 and is connected nonrotatably to the crankshaft 86 of the internal combustion engine 12 radially on the outside by means of a torque-transmitting plate 84, especially one with axial flexibility (flexplate). As a result, axial crankshaft vibrations, a certain axial tolerance possibly associated with the installation of the electromotive drive module 18a, and changes in length which occur during operation can be easily compensated. This makes it possible to eliminate undesirable stresses in the torque-transmitting elements located in the path of torque transmission between the internal combustion engine 12 and the transmission 14.

The second clutch 30, which serves to transmit torque between the rotor 24 and the input shaft 32 of the transmission 14, is designed as a wet-running clutch, where its housing 88, which simultaneously functions as a clutch input element, is connected nonrotatably to the rotor 24 of the electric machine 22, which can be realized as a permanent connection such as a weld or possibly as a detachable connection by means of screws or bayonet joints. The housing 88 is supported on the transmission input shaft 32 in a manner familiar to the man of the art. The wet-running clutch 30 is shown only in outline in the figure, and with respect to the details of construction, it is designed preferably but not exclusively in the manner described in US 2004/0195068, which is incorporated herein by reference.

In addition to the fluid-filled or fillable housing 88, the second clutch 30 also includes at least one first friction element, which can rotate in common with the housing around the input shaft 32 of the transmission 14; and at least one second friction element, which rotates around the input shaft 32 in common with a takeoff element. The second friction element can be brought into contact with at least one first friction element to produce a frictional interaction, and where at least one first friction element and the minimum of one second friction element each have a friction lining carrier, which carries a friction lining arrangement on each of the frictionally active axial sides of this friction element. A fluid transport surface arrangement for generating a fluid circulation flowing around at least certain areas of the friction elements is provided on at least one friction element equipped with a friction lining carrier with a friction lining arrangement.

A takeoff hub, which is connected in the known manner by means of a set of teeth to the input shaft 32 of the transmission 14, serves as the takeoff element or output element.

The housing 88 has a multi-part design including a housing part 90, facing the transmission 14, by which it is permanently connected radially on the inside to a pump hub 92, which is supported by a bearing 89 on the transmission bell or bell housing 16. The pump hub 92 is a component of a pump 48, mounted on the transmission 14. The pump builds up a fluid pressure and can thus maintain a uniform exchange of oil between the clutch 30 and the transmission 14. Through the special design of the internal components of the clutch, a forced circulation of fluid, which can be extremely rapid if necessary, can be achieved inside the clutch 30.

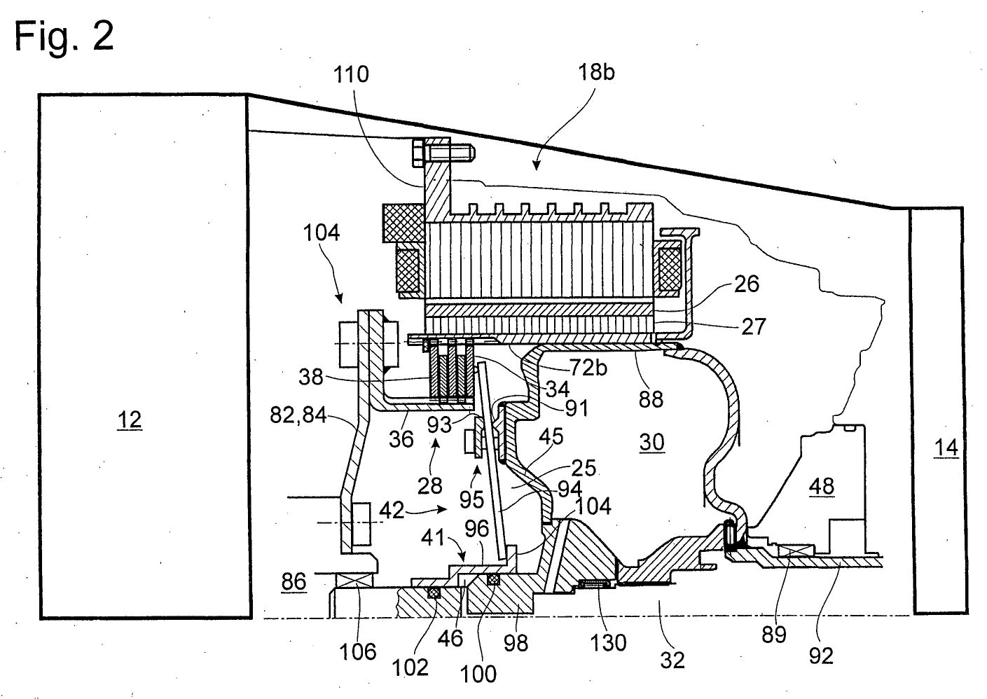

FIG. 2 shows a drive module 18b fundamentally similar to that explained above, except that it does not have an intermediate housing wall and that the clutch 28 is of the “normally closed” type, being kept closed in the unactuated state by the action of an actuating element 94 designed in a manner similar to that of a diaphragm spring, which acts on the clutch plates 34. The clutch 28 can be opened by the hydraulic cylinder 41, acting in opposition to the force of the actuating element 94. The actuating element 94 is supported axially between two blades 91, 93 of a holder 95, mounted on the housing 88 of the clutch 30. A design of this type makes it necessary to have an additional hydraulic pump in the drive system for purely electrical startup. This pump works independently of the operating state of the internal combustion engine, so that, when the clutch 28 is to be operated as an inertial starting clutch, it can first be opened under hydraulic control before the startup process begins.

The hydraulic cylinder 41 provided to actuate the clutch 28 has a stepped piston 96, which is situated in the radially inner area and which extends essentially in the axial direction. The piston is guided on a housing hub 98 of the second clutch 30 and cooperates with the hub to form the pressure space 46, which is sealed off in turn by two ring seals 100, 102 mounted on the housing hub. The stepped piston 96 has a radial flange 104 at one end, against which the actuating element 94 can act so that force can be transmitted to the plate package 34, 38. The particular advantage of the small outer diameter of the cylinder achievable by the use a stepped piston 96 is that the rotating fluid thus generates only a small amount of centrifugal force, which can be compensated for very easily. The centrifugal force can be compensated here without any special effort simply by the restoring force of the actuating element 94.

In the two exemplary embodiments according to FIGS. 1 and 2, the fluid is supplied to the actuating cylinder 41 through a connection provided radially inside the cylinder. This connection leads to a fluid channel in the transmission input shaft 32. The clutches 28, 30 are controlled by a transmission controller (not shown). Alternatively, fluid can also be introduced from the outside into the interior of the housing of the wet-running clutch 30 by means of a rotary feed. The fluid would then be conducted through or around the wet-running clutch 30 to the hydraulic cylinder 41.

It should be mentioned that, as an alternative to the double or two-ended support of the rotor 24 via the rotor carrier 72 and the housing 88 as shown in FIG. 1, the rotor can be supported at only one end, namely, by the housing 88 of the second clutch 30, the plate carrier 36 then being connected directly, as shown in FIG. 2, to the driveplate 82 or flexplate 84 by means of, for example, a screw joint 104. In this housing, the intermediate wall 68 and the rotor carrier 72 can be eliminated. Of course, there is also the possibility of connecting the inner plate carrier 36 directly to the crankshaft 86.

In the exemplary embodiment explained on the basis of FIG. 1, the transmission input shaft 32 does not project beyond the wet-running clutch 30. According to FIG. 2, as an alternative, there is also the possibility, in conjunction with the single-ended support of the rotor 24, of supporting the clutch 30 by its clutch hub 98 in the crankshaft 86 by means of a pilot bearing 106, or, in yet another variant, to support the transmission input shaft 32 in the known manner in a pilot bearing on the crankshaft 86 of the internal combustion engine 12.

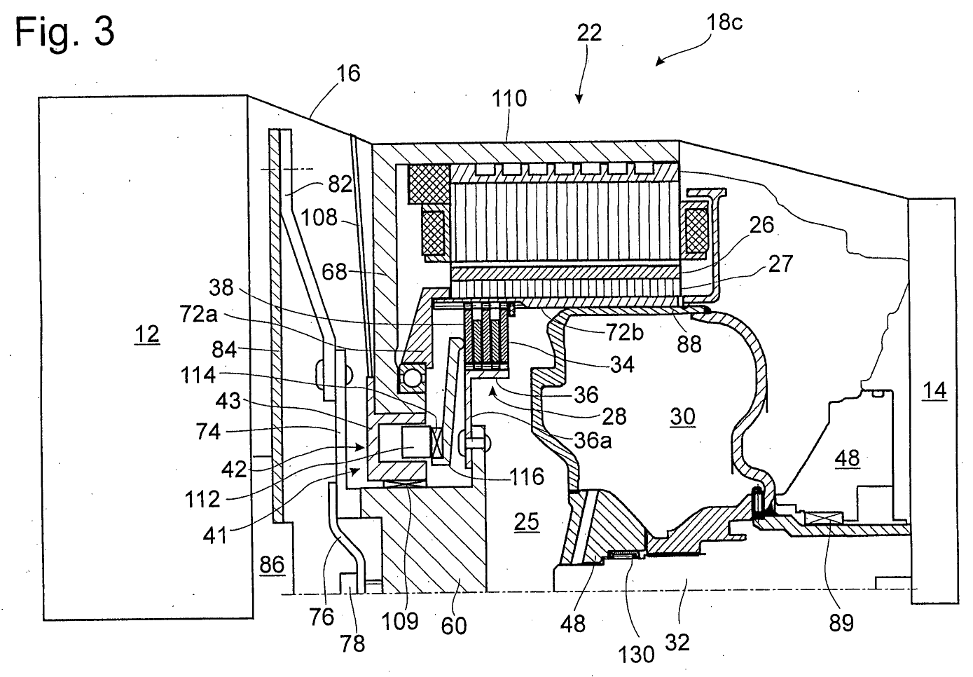

On the basis of a drive module 18c, FIG. 3 shows yet another alternative way of actuating the clutch 28. In this housing, the clutch is actuated on the side facing the internal combustion engine 12. For this purpose, a pressure line 108 proceeds from the wall of the transmission bell housing 16, that is, from the radially outside area, to an actuating cylinder 41, mounted concentrically by means of a radial bearing 109 around the clutch hub 60. The cylinder is supported by its housing 43 axially against the intermediate wall 68, which, in FIG. 3, is a component of a stator carrier 110 of the electric machine and which serves simultaneously as a housing. The stator carrier 110 thus encloses not only the electric machine 22 but also the clutches 28 and 30, as a result of which the drive module 18c can be made even more compact and thus becomes extremely easy to install in a vehicle.

In the housing of the “normally open” clutch shown here, the piston 112 of the actuating cylinder 41 acts by way of a clutch-engagement bearing 114 and a spring lever plate 116 on the plate package 34, 38. It is an advantage of this embodiment that no changes of any kind are needed to the input side of the automatic transmission 14. The only measures which must be taken involve the actuation of the clutch 28 provided in addition to the automatic converter. The clutch can be actuated by means of a pressure medium supply, for example, which is integrated into the hydraulic system of the transmission 14 or provided as an external system.

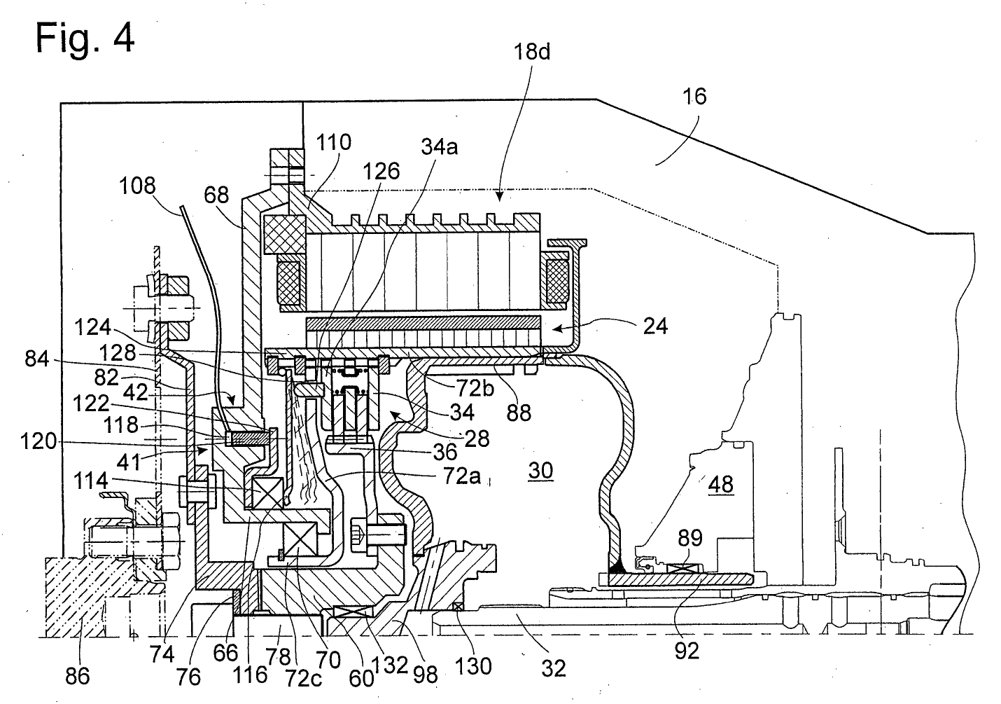

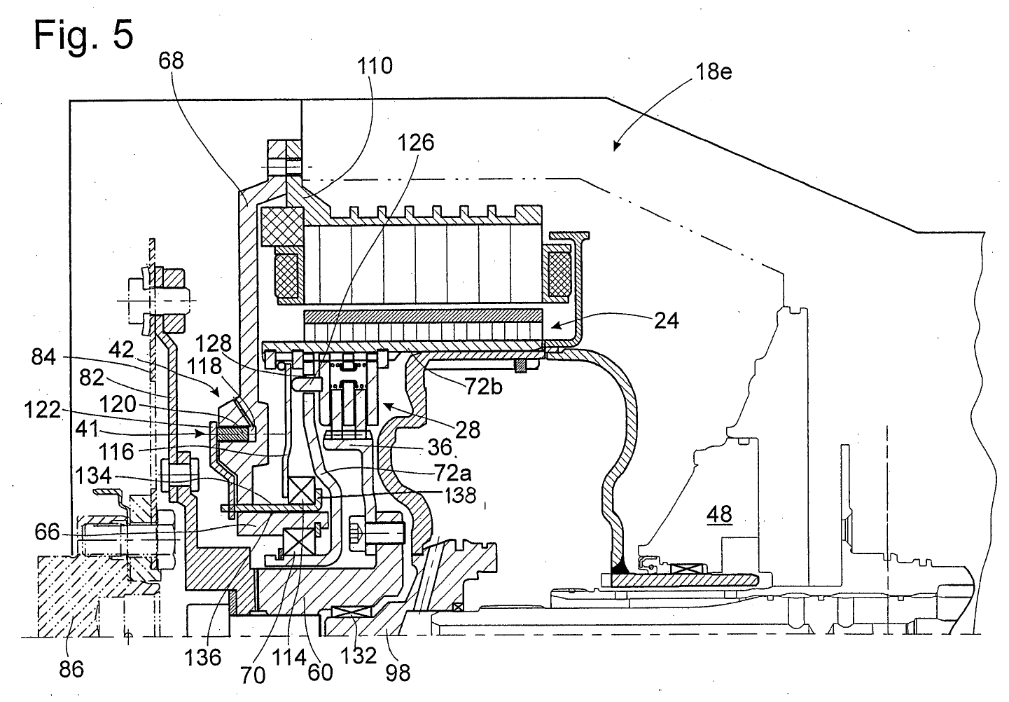

Common to the exemplary embodiments explained on the basis of FIGS. 1 and 3 is that both the input and the output part of the first clutch 28, that is, the inner plate carrier 36 and the rotor 24, which functions as the outer plate carrier, are supported and braced on or by means of the intermediate housing wall 68. In the following, an alternative support of the inner plate carrier 36 of the first clutch 28 and additional design variants of the actuating device 42 for the clutch 28 are presented on the basis of FIGS. 4 and 5.

In terms of its basic design, the electromotive drive module 18d shown in FIG. 4 is based initially on that shown in FIGS. 1 and 3. As previously explained, the housing 88 of the second clutch 30, the rotor 24 with its rotor carrier 72, and the outer clutch plates 34 of the first clutch 28 are connected nonrotatably to each other. These elements are supported at one end by way of the bearing 89 located between the pump hub 92 and the pump arrangement, and at the other end they are supported on the transmission housing 16 via the intermediate housing wall 68 by way of a fixed bearing 70, mounted on the inner circumferential surface of the tubular section 66, where the radial section 72a of the rotor carrier 72 has a tubular extension 72c, which fits into the tubular section 66 of the intermediate wall 68 and is connected there to the inner ring of the bearing 70. The bearing 70 has the additional job of absorbing the engaging forces of the first clutch 28, which preferably serves as an inertial starting clutch, and any axial forces which may be exerted by the assemblies connected to the rotor 24.

The first clutch 28 is designed as a “normally open” clutch for push-type actuation, for which purpose a concentric hydraulic slave cylinder 41 is integrated into the intermediate wall 68. To form the cylinder housing and the pressure space, a ring-shaped recess 118 oriented toward the clutch 28 is introduced into the intermediate wall 68. A ring-shaped piston 120 fits into this recess. The ring-shaped piston 120, on the side facing away from the pressure space, rests against a cranked engaging plate 122, which can transmit the force required to close the clutch 28 to the fixed bearing ring of an axially movable clutch-engaging bearing 114 and onward from the rotating bearing ring of that bearing, i.e., the ring facing the clutch 28, to the radially inner edge of a spring lever plate 116. The outer area of the spring lever plate 116 is supported pivotably on a carrier section 124 projecting axially beyond the electrically active part of the rotor 24 and acts on several transmission elements 126, which are uniformly distributed around a graduated circle. These transmission elements are formed on the outer plate 34a adjacent to the lever plate 116 and project through segment-like access openings 128 in the rotor carrier 72a.

As an alternative to the integrated design described above, the actuating cylinder 41 can be an external element mounted on the intermediate housing wall 68. Regardless of how the actuating cylinder 41 is designed, it is actuated by way of a pressure line 108, previously explained in conjunction with FIG. 3.

The direct, radially adjacent arrangement of the two bearings 70 and 114, i.e., one radially inside, the other radially outside the tubular section 66 of intermediate wall 68, has the effect of almost completely eliminating any flow of force between these two bearings 70, 114 in the event of an interaction between them.

The transmission input shaft 32 projects into the second clutch 30 and is supported there on a bearing 130, preferably mounted on the housing hub 98.

The inner plate carrier 36, as previously explained on the basis of FIG. 1, is connected nonrotatably to the crankshaft 86 by means of the elements 60, 74, 82, and 84. In contrast to FIGS. 1 and 3, the inner plate carrier 36 is not, however, supported here on the intermediate wall 68 but rather is supported radially by means of a bearing 132 mounted on the housing hub 98. In this way, wobbling movements introduced by the crankshaft 86 can be absorbed as early as the driveplate 82 and/or the flexplate 84, as a result of which the load on the inner plate carrier 36 can be decreased and the life-span of the first clutch 28 increased. In addition, the bearing 132 makes it easier to assemble the drive module 18d.

The drive module 18e of FIG. 5 differs from that of FIG. 4 only with respect to the design of the clutch 28 and its actuating device 42. The clutch 28 in this housing is designed as a pull-type, “normally closed” clutch; that is, it is opened by the exertion of pressure from the actuating cylinder 41, which thus interrupts the transmission of torque between the crankshaft 86 and the rotor 24. The recess 118 is executed on the side of the intermediate wall 68 facing the crankshaft 86, where the engaging plate 122 cooperating with the piston 120 acts on the side of the release bearing 114 facing the clutch 28 by way of an additional, axially guided transmission element 134. The transmission element 134 is designed as an actuating sleeve, for example, with axial slots in one end, where the webs remaining between the slots pass through several access openings 136 in the intermediate wall 68. It can be seen that the clutch-release bearing 114 is mounted on the outer circumferential surface of the transmission element 134 and is clamped axially between the spring lever plate 116 and a radially outward-pointing, ring-shaped collar 138 on the transmission element 134. The pull-type design of the clutch 28 shown here makes it possible to select a favorable speed reduction ratio and thus also to decrease the disengaging forces, which must also be supported by the fixed bearing 70.

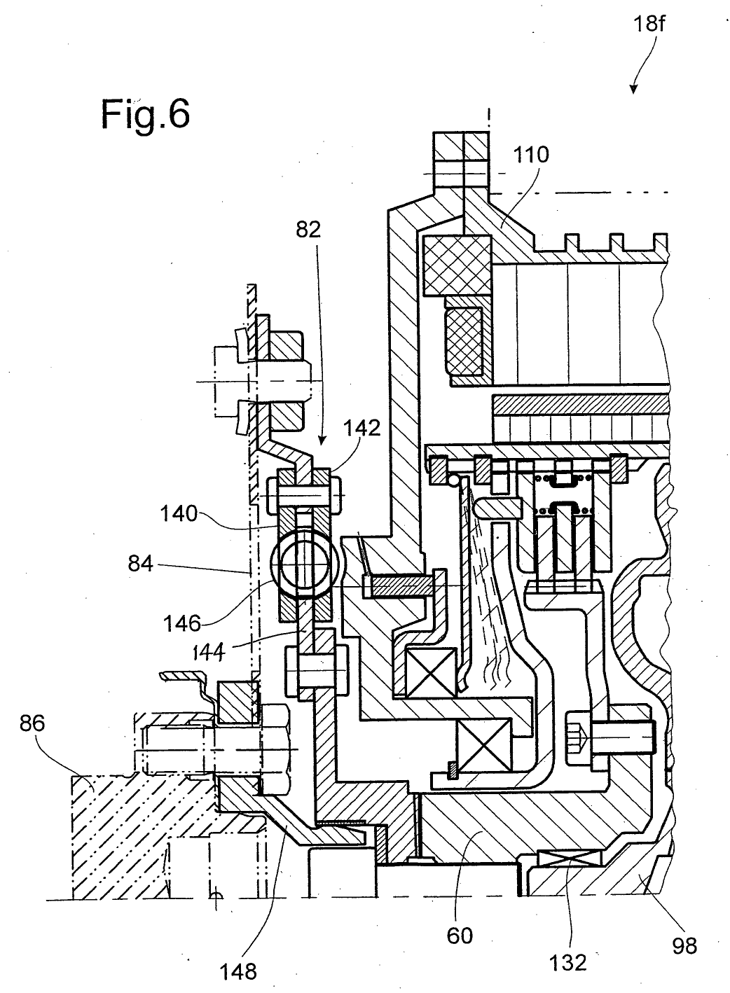

In the housing of the exemplary embodiments of FIGS. 1-5, it is also possible as an option to increase the driving comfort by integrating a torsional vibration damper arrangement between the driveplate 82 and the inner plate carrier 36 to damp undesirable torsional vibrations. This damping arrangement can contribute significantly to the elimination of noise and wear on the input profile 34 of the first clutch 28. The second clutch 30 can also have one of these torsional vibration damper arrangements assigned to it, as will be explained on the basis of FIGS. 6-9.

According to the drive module 18f shown in FIG. 6, it is also advantageous to integrate a compensating element 140 into the driveplate 82. For this purpose, for example, the driveplate 82 is divided into an input part 142 and an output part 144, where, between these, several energy-storing springs 146, which are compressible essentially in the circumferential direction, are inserted. As a result, the input part 142 is mounted so that it can pivot within a certain range in the axial plane and can also shift position radially with respect to the output part 144. In contrast to a torsion damper designed primarily to eliminate vibrations, the input part 142 and the output part 144 are able to rotate with respect to each other in the lateral plane to only a very small extent, such as over a sector of no more than 3°.

The compensating element 140 has here in particular the task of providing radial cushioning between the crankshaft 86 and the bearing 132 installed between the housing hub 98 and the clutch hub 60. Because of the limited ability of the parts 142, 144 to rotate relative to each other, torsional vibrations are damped to a negligible extent.

The desired radial cushioning serves to compensate for axial offsets between the crankshaft 86 and the transmission input shaft 32 and for wobbling movements of the crankshaft 86, so that these offsets and movements do not have to be absorbed by the flexplate 84 alone. The radial loads on the bearings 70, 132, and 89 are thus decreased. In addition, a mounting pin 148 is attached to the crankshaft 86. During the process of installing the complete module in the internal combustion engine, this pin serves a precentering function but no bearing function.

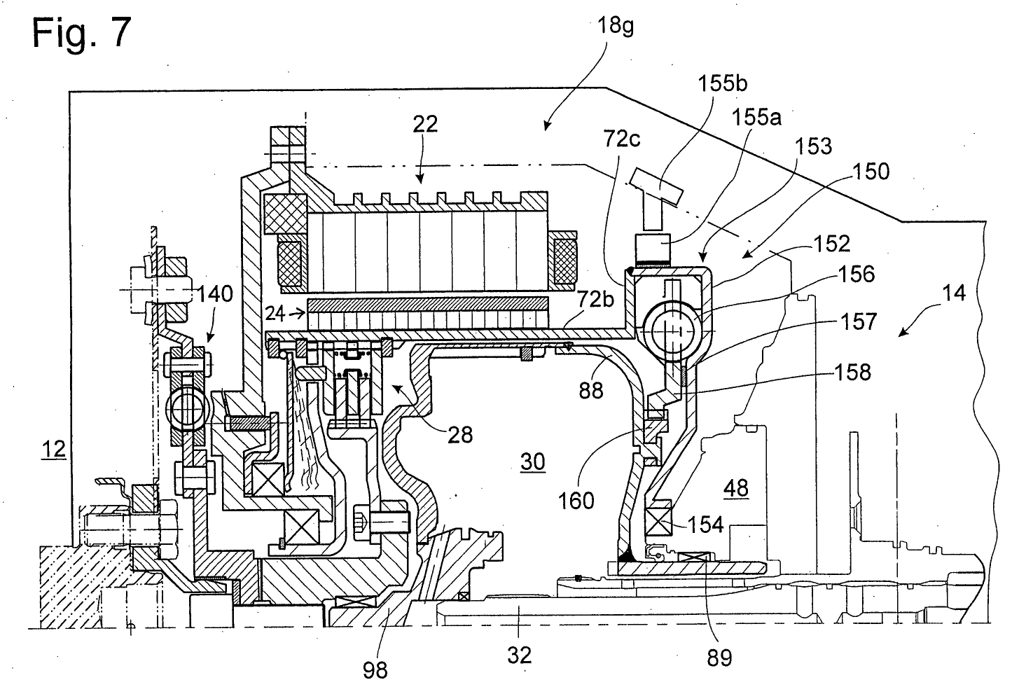

FIGS. 7-10 show drive modules 18g-i, in which the rotor 24 of the electric machine 22 is connected by way of its rotor carrier 72, 72b nonrotatably to the input part of a torsional vibration damper arrangement 150, preferably designed as a dual-mass flywheel. The drive module 18g of FIG. 7 is based in particular on the exemplary embodiments shown in FIGS. 4 and 6. The axial section 72b of the rotor carrier 72 is for this purpose extended on the transmission side beyond the rotor yoke 27 and provided with a disk section 72c, which, in common with a shell 152, forms the housing 153 and also the input part of the dual-mass flywheel 150, which is supported by a bearing 154 via the pump arrangement 48 on the transmission 14. The connection between the disk section 72c and the shell 152 can be permanent, e.g., a welded joint, or detachable, e.g., a bayonet joint. The housing 153 holds several energy-storing springs 156, arranged around the circumference, one end of each one being supported against the housing 153, while the other end is supported against an output part 158, which is connected preferably in a positive manner and especially by means of a set of teeth to the input part of the second clutch 30, that is, to its housing 88. The latter carries for this purpose an element such as a gear wheel 160, which engages positively with the output part 158. The connection between the torsional vibration damper arrangement 150 and the clutch 30 is thus detachable, which offers considerable advantages during the assembly or disassembly of the drive module 18g. A friction device 157 for effective vibrational damping is in working connection on one side with the shell 152, more precisely the input part 152, and on the other side with the output part 158. A signaling structure 155 in the form of, for example, a tooth-gap profile 155a or a continuous one-track or two-track contour which can be scanned by a sensor unit 155b for contactless acquisition of rotor position data for the control of the electric machine 22 is provided on the outer circumferential surface of the shell 152.

It can also be seen that, with respect to the path of torque transmission, the torsional vibration damper arrangement 150 is downline from the first clutch 28 when the vehicle is being driven by the internal combustion engine. This arrangement makes it possible, first, for the internal combustion engine 12 to be started extremely quickly by the electric machine 22 because of the low mass moments of inertia; second, the arrangement makes it possible for the masses of the input and output parts of the torsional vibration damper arrangement 150 to be distributed optimally for the damping of torsional vibrations when the internal combustion engine is driving the vehicle. In this way, therefore, the previous problems and compromises associated with the job of designing a torsional vibration damper arrangement 150 to be located between the starting clutch 28 and the internal combustion engine 12 are elegantly avoided.

It can also be seen that the energy-storing springs 156 of the torsional vibration damper arrangement 150 are located radially approximately in the area of the rotor 24 and the radially outer section of the housing 88, whereas axially they are located near the second clutch 30, which makes it possible to give the drive module 18g a compact design.

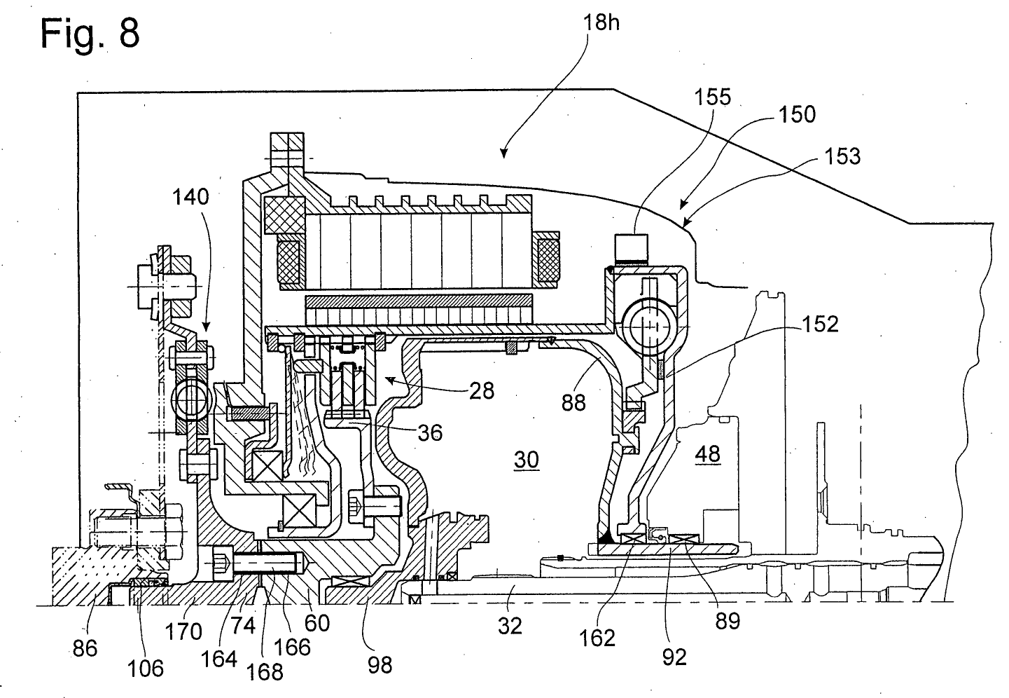

FIG. 8 shows yet another drive module 18h, which differs from that of FIG. 7 in the following details. Here the housing 153 forming the input part of the torsional vibration damper arrangement 150 is supported on the pump hub 92 of the second clutch 30 by a bearing 162. It is advantageous that the bearing 162, in contrast to the variant shown in FIG. 7, is not required to execute any rotational movement; on the contrary, it merely pivots over relatively short distances, which are determined by the pivot range of the torsional vibration damper arrangement 150. The bearing 162 can therefore be designed as a low-cost journal bearing, which is advantageous.

In FIG. 8, furthermore, yet another way in which torque can be introduced to the clutch hub 60, which is connected nonrotatably to the inner plate carrier 36, and another way for supporting that hub are shown. The hub is connected to the connecting disk 74 by means of the previously explained serrations, where the connecting disk 74 has several through-holes 164 on a graduated circle, and the clutch hub 60 has correspondingly arranged threaded bores 166 to accept threaded bolts 168. The connecting disk 74 has a central axial pin 170, which is mounted in the pilot bearing 106 of the crankshaft 86 and is supported there, as a result of which the support of the parts 60, 74 and thus also of the transmission input shaft 32, which is supported inside the second clutch 30, is improved even more.

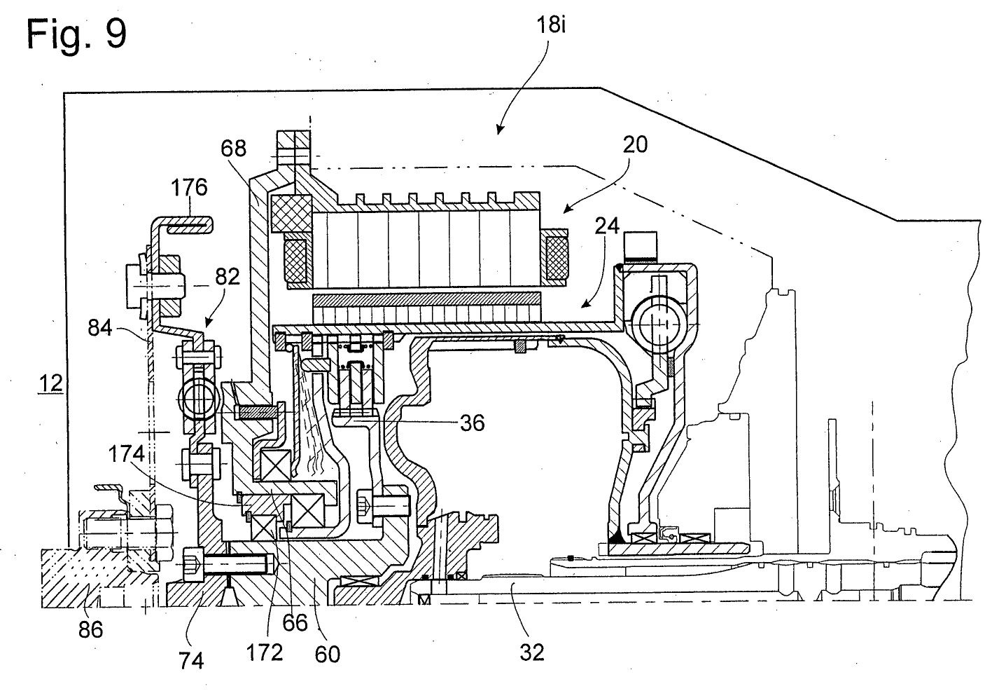

Yet another alternative variant of the support of the inner plate carrier 36 is shown in FIG. 9, where, in contrast to FIG. 8, there is no axial pin 170 on the connecting disk 74, and the clutch hub 60 is supported on the intermediate housing wall 68 by a roller bearing 172. For this purpose, a bearing bush 174 is fixed axially in place in the tubular section 66; the bearing 172 is mounted radially inside this bush, which in turn holds the bearing axially in place. In this way, the transmission input shaft 32 can also be supported on the intermediate housing wall 68. At the same time, the inner plate carrier 36 is isolated more effectively from the wobbling movements of the crankshaft 86.

As an alternative to the arrangement of the torsional vibration damper arrangement 150 shown in FIGS. 6-9, the arrangement can be integrated into the second clutch 30 and mounted together with it in a common housing. A torsional vibration damper arrangement can be designed there as an element of the input part or of the output part of the clutch.

In all of the exemplary embodiments presented so far, it can also be advantageous for the flexplate 84 and/or the driveplate 82, as shown in FIG. 9, to be designed with additional mass 176. This is located preferably in the radially outer area between the rotor 24 and the stator 20. To create this additional mass 176, the radially outer area of the driveplate 82 is bent over axially and then folded. It is therefore possible effectively to adjust the mass moment of inertia of the elements which must be accelerated by the engine's crankshaft when the engine is to be started and thus to influence the chronological course of a starting process in the desired way. Increasing the mass moment of inertia in the path of torque transmission between the crankshaft 86 and the inner plate carrier 36 can lower the torque peaks acting on the first clutch 28 from the internal combustion engine 12 side and thus help to prolong the life of the clutch.

The electromotive drive module 18a-i is prefabricated as a structural unit, this unit comprising at minimum the electric machine 22 and the two clutches 28, 30. The two clutches and the rotor 24 of the electric machine 22 form a subunit. Depending on the design, the intermediate wall 68 is also part of the drive module 18. This drive module 18a-i therefore represents an additional assembly unit available to transmission manufacturers, or auto manufacturers can install it themselves between the internal combustion engine and the transmission. The module 18a-f can be accommodated inside the transmission bell housing 16 and mounted on the transmission input shaft. Alternatively, the intermediate wall 68 can be designed as an independent housing, which can be installed between the front end of the internal combustion engine 12 and the transmission 14. For final installation, the stator 20 of the electric machine and possibly also the intermediate wall 68 are attached to the transmission housing 16 and, for the production of a torque-transmitting connection, the crankshaft 86 of the internal combustion engine 12 is connected to the flexplate or optionally to the driveplate or directly to the inner plate carrier 36.

Through the implementation of the electromotive drive module described above, a versatile hybrid drive is created, which makes it possible for the vehicle to be driven by the electric motor alone after the internal combustion engine has been disconnected by the opening of the first clutch. While the electric machine is operating as a motor, it can drive the pump arrangement of the automatic transmission directly and thus make it possible for all hydraulic transmission functions to be carried out even during periods when the vehicle is being driven by electricity alone.

In cooperation with the first clutch, the electric machine can start the internal combustion engine inertially. The powertrain 10 and especially the electromotive drive module 18a-i are designed in such a way, as illustrated in FIGS. 1-6, that the lowest possible mass moment of inertia is present between the input element of the first clutch 28, i.e., the inner plate carrier 36, and the crankshaft 86, which allows the engine to be started as quickly as possible.

While the rotor is rotating, this clutch is closed—and the turned-off internal combustion engine thus connected—in such a way as to increase the drive torque of the electric machine to the extent required to start the internal combustion engine. The drive torque at the wheels remains unaffected by this, and therefore the occupants of the vehicle remain almost completely unaware of this process.

It is also possible, however, to use the closed clutch 28 to connect the turned-off internal combustion engine nonrotatably to the rotor of the electric machine and to crank up both assemblies from a standstill together. This is known as a “direct start”.

When the vehicle is being driven by the internal combustion engine, the first and second clutches are both closed. The electric machine is running in this housing in generator mode. While the vehicle is being driven, the generator mode can, if necessary, be interrupted for a certain period of time, however, so that the electric machine can operate as a motor and thus assist the internal combustion engine by introducing additional torque to the vehicle powertrain.

When the vehicle is stopped and the first and second clutches are open, low drive rpm's of the electric machine are sufficient to maintain the fluid pressure in the transmission, which is a prerequisite for the realization of a start-stop function.

With respect to control technology, it is advisable to coordinate the hybrid vehicle control with the automatic transmission control and possibly to combine these control functions into a common control system.

In summary, the electromotive drive module explained above and a vehicle equipped with such a module offer a wide range of functionality in a very small space. The development effort is modest, because a module of this type can be built out of known individual components, a fact which also offers considerable cost advantages in terms of series production. With respect to the unit formed by the internal combustion engine and the transmission, the drive module can be located between the internal combustion engine and the transmission without increasing the amount of space required. Through the use of a wet-running clutch according to the specification, a large amount of start-up power can be provided. Because the electric machine is of the internal rotor type, furthermore, a low mass moment of inertia is also realized, which is desirable.

It should also be pointed out in particular that the scope of disclosure of the present patent application also comprises exemplary embodiments not illustrated in the drawings; that is, embodiments in which elements or variant arrangements of certain individual exemplary embodiments as explained on the basis of the figures can be transferred to other exemplary embodiments and can correspondingly supplement these arrangements or elements or replace them. This pertains in particular to the arrangement of the torsional vibration damper 150, of the compensating element 140, and of the additional mass 176, and to the way in which the rotor 24, the transmission input shaft 32, the second clutch 30, and the inner plate carrier 36 are supported.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. Electronic drive module for installation in a housing between an internal combustion engine and a transmission of a motor vehicle powertrain, said module comprising:
an electric machine comprising a stator and a rotor;
first and second clutches which can connect the rotor as desired to at least one of the engine and the transmission for the transmission of torque.

2. The drive module of claim 1 wherein the rotor is radially inside the stator.

3. The drive module of claim 1 wherein the stator comprises a stator carrier which can be fixed to the housing.

4. The drive module of claim 1 wherein the stator comprises a stator carrier which is made as one piece with the housing.

5. The drive module of claim 1 further comprising an intermediate wall which can be fixed to the housing or the stator, the rotor comprising a rotor carrier which is supported on the intermediate wall.

6. The drive module of claim 1 wherein the second clutch comprises a clutch housing which supports the rotor.

7. The drive module of claim 1 further comprising a receiving space radially inside the electric machine, the first and second clutches being located in the receiving space.

8. The drive module of claim 7 wherein the receiving space is essentially within an axial dimension of the electric machine.

9. The drive module of claim 1 wherein the first clutch provides torque transmission between the electric machine and the internal combustion engine, the first clutch being a dry clutch comprising an inner plate carrier carrying inner plates and an outer plate carrier carrying outer plates.

10. The drive module of claim 9 wherein the second clutch provides torque transmission between the electric machine and the transmission, the second clutch being a wet clutch.

11. The drive module of claim 9 wherein the second clutch comprises a housing part, the inner plate carrier of the first clutch being supported on the housing part of the second clutch.

12. The drive module of claim 9 wherein the rotor is carried by the outer plate carrier.

13. The drive module of claim 9 wherein the inner plate carrier can be connected to a crankshaft of the internal combustion engine.

14. The drive module of claim 13 further comprising a compensating element between the inner plate carrier and the crankshaft, the compensating element compensating any radial offset between the clutches and the internal combustion engine.

15. The drive module of claim 13 further comprising a flexible torque transmitting plate between the inner plate carrier and the crankshaft.

16. The drive module of claim 1 further comprising a hydraulic actuating cylinder for actuating the first clutch, the hydraulic actuating cylinder comprising a housing which forms part of said second clutch.

17. The drive module of claim 16 wherein said part of said second clutch is a radially extending housing part having a profile, the actuating device further comprising a piston having a profile which conforms substantially to the profile of the housing part.

18. The drive module of claim 17 wherein the piston interacts directly with the inner and outer plates.

19. The drive module of claim 16 wherein said part of said second clutch is a housing hub, said actuating device further comprising an axially stepped piston surrounding said housing hub.

20. The drive module of claim 19 further comprising a holder fixed to said housing which forms part of said second clutch, and an actuating element supported by said holder and acted on by said piston for actuating the first clutch.

21. The drive module of claim 1 further comprising:
an intermediate housing wall which can be fixed to the housing; and
a hydraulic actuating cylinder for actuating said first clutch, said actuating cylinder comprising a piston which is supported for movement on said intermediate housing wall.

22. The drive module of claim 22 further comprising an axially moveable clutch release bearing which is in working connection with said piston.

23. The drive module of claim 21 wherein said intermediate housing wall comprises a tubular section on which said clutch release bearing is mounted.

24. The drive module of claim 1 wherein said rotor comprises a rotor carrier having an access opening for actuating said first clutch.

25. The drive module of claim 1 wherein the first clutch is a normally open clutch having push-ype actuation.

26. The drive module of claim 1 wherein the first clutch is a normally closed clutch having an access opening for pull-type actuation.

27. The drive module of claim 1 wherein the second clutch can be supported on an input shaft of the transmission.

28. The drive module of claim 1 wherein the second clutch comprises a hub which can be supported on a crankshaft of the internal combustion engine.

29. The drive module of claim 1 further comprising:
a hydraulic actuating cylinder for actuating the first clutch; and
a hydraulic pump for actuating the actuating cylinder, the hydraulic pump operating independently of the operating state of the internal combustion engine.

30. The drive module of claim 1 further comprising a hydraulic actuating cylinder for actuating the first clutch, the hydraulic actuating cylinder being connectable with a fluid channel in an input shaft of the transmission.

31. The drive module of claim 1 further comprising a torsional vibration damper having an input part and an output part, the rotor being connected nonrotatably to the input part of the torsional vibration damper, the output part being connected nonrotatably to an input part of the second clutch.

32. The drive module of claim 31 wherein the input part of the torsional vibration damper can be supported on the housing.

33. The drive module of claim 31 wherein the input part of the torsional vibration damper arrangement is supported on the input part of the second clutch.

34. The drive module of claim 31 wherein the rotor comprises a rotor carrier which forms part of a housing of the torsional vibration damper.

35. The drive module of claim 34 further comprising a signaling structure on the housing of the torsional vibration damper, and a stationary sensor for contactless scanning of the signaling structure in order to determine the position of the rotor.

36. The drive module of claim 15 further comprising:
a drive plate between the inner plate carrier and the flexible torque transmitting plate; and
an additional mass carried by at least one of said drive plate and said flexible torque transmitting plate in order to increase the moment of inertia of the drive module.

37. The drive module of claim 1 wherein the module is a prefabricated unit which can be installed in a bell housing in a motor vehicle powertrain.
